(19) United States
(12) Patent Application Publication
(10) Pub. No.: US 2024/0364620 A1
(43) Pub. Date: Oct. 31, 2024

(54) METHOD AND APPARATUS FOR DISTRIBUTED DATA NETWORK TRAFFIC OPTIMIZATION

(71) Applicant: VMware, LLC, Palo Alto, CA (US)

(72) Inventors: Victor de Souza Lima e Silva, San Francisco, CA (US); Archit Baweja, San Francisco, CA (US); Nithin Michael, San Francisco, CA (US)

(21) Appl. No.: 18/766,086

(22) Filed: Jul. 8, 2024

Related U.S. Application Data
(63) Continuation of application No. 18/222,868, filed on Jul. 17, 2023, now Pat. No. 12,034,630.
Application No. 18/222,868 is a continuation of application No. 17/240,906, filed on Apr. 26, 2021, now Pat. No. 11,706,126.
Application No. 17/240,906 is a continuation of application No. 16/216,235, filed on Dec. 11, 2018, now Pat. No. 10,992,558.
Application No. 16/216,235 is a continuation of application No. 15/803,964, filed on Nov. 6, 2017, now abandoned.

(51) Int. Cl. H04L 45/00; H04L 43/062; H04L 43/0829; H04L 43/0852; H04L 43/0864; H04L 43/0876; H04L 43/0882; H04L 45/12; H04L 45/121; H04L 45/24; H04L 45/745; H04L 47/122

(52) U.S. Cl. CPC H04L 45/22; H04L 43/062; H04L 43/0864; H04L 43/0876; H04L 45/123; H04L 45/24; H04L 45/745; H04L 47/122; H04L 43/0829; H04L 43/0852; H04L 43/0882; H04L 45/121; H04L 45/56

(57) ABSTRACT

Embodiments disclosed include a method and apparatus for global traffic control and optimization for software-defined networks. In an embodiment, data traffic is optimized by distributing predefined metrics (data traffic information) to all controllers in the network. The predefined metrics are specific to local network switches and controllers, but are distributed to all peers at configurable intervals. “Local” as used herein implies one POP and its associated switch and controller. The method of distribution of local POP metrics is strictly in band using a packet as defined by the protocol used by the data network.

### RELATED APPLICATIONS

This application is a continuation of U.S. patent application Ser. No. 18/222,868, filed Jul. 17, 2023. U.S. patent application Ser. No. 18/222,868 is a continuation of U.S. patent application Ser. No. 17/240,906, filed Apr. 26, 2021, now patented as U.S. Pat. No. 11,706,126. U.S. patent application Ser. No. 17/240,906 is a continuation of U.S. patent application Ser. No. 16/216,235, filed Dec. 11, 2018, now issued as U.S. Pat. No. 10,992,558. U.S. patent application Ser. No. 16/216,235 is a continuation of U.S. patent application Ser. No. 15/803,964, filed Nov. 6, 2017. The contents U.S. patent application Ser. No. 18/222,868, U.S. patent application Ser. No. 16/216,235 now issued as U.S. Pat. No. 10,992,558, and U.S. patent application Ser. No. 17/240,906, now patented as U.S. Pat. No. 11,706,126, are hereby incorporated by reference.

### FIELD OF THE INVENTION

The application disclosed herein is in the field of optimizing the performance of data networks.

### BACKGROUND

Data networks include the transmission of audio data and video data at increasingly high volumes and speeds. One of the challenges in designing and operating data networks is determining what routes through the network are most efficient at any one time. Routers, switches and controllers may be hardware or software or a combination of both. The proliferation of virtual machines not tied to any particular geographic location lends itself to using the term “point of presence” or “POP” for network nodes. For a given network, at any one time, each POP must determine how best to route data packets. Some POPS may be experiencing very high volume, and even if they are in a shortest path, might be best left out of the route. Several routing solutions are currently known. As an example of a prior art data network, refer to FIG. 1.

FIG. 1 is a prior art data network 100 that includes example POPs (or switches) 102A, 102B, 102C and 102D that route traffic for physical locations Palo Alto, Hong Kong, London, and Mumbai, respectively. Routing between POPs requires communication between POPs. This communication includes other information beside the actual data.

A typical prior art method of this communication is “out of band”, which is illustrated by controller-to-controller link 107. Link 107 does not share the same data plane, or the same the data links, or “pipes” 109 as the data network itself. This out of band communication between controllers requires additional overhead at each end, in part because a different network is used (for example internet 103, but that is not limiting). In addition, to communicate with different, potentially different, or possibly legacy controllers, one or more different protocols (in addition to the actual data traffic protocol) must be managed.

There are some current in band solutions for communication between POPs, however they are focused on communication between actual hardware routers and thus include overhead in the form of establishment of connection, trust issues, handshakes, keeping state of neighbor routers, etc.

It is desirable to define a communication method between data network POPs that allows most efficient communication of data traffic metrics to all POPs in a network so that each POP can make optimized routing decisions at any time, yet does not burden each POP with addition overhead for the purpose.

### BRIEF DESCRIPTION OF THE FIGURES

FIG. 1 is a block diagram of a prior art data network.

FIG. 2 is a block diagram of a data network according to an embodiment.

FIG. 2A is a block diagram of point of presence (POP) according to an embodiment.

FIG. 3 is a flow diagram illustrating a data routing method according to an embodiment.

FIG. 4 is a flow diagram illustrating a data routing method according to an embodiment.

FIG. 5 is a diagram illustrating a control packet according to an embodiment.

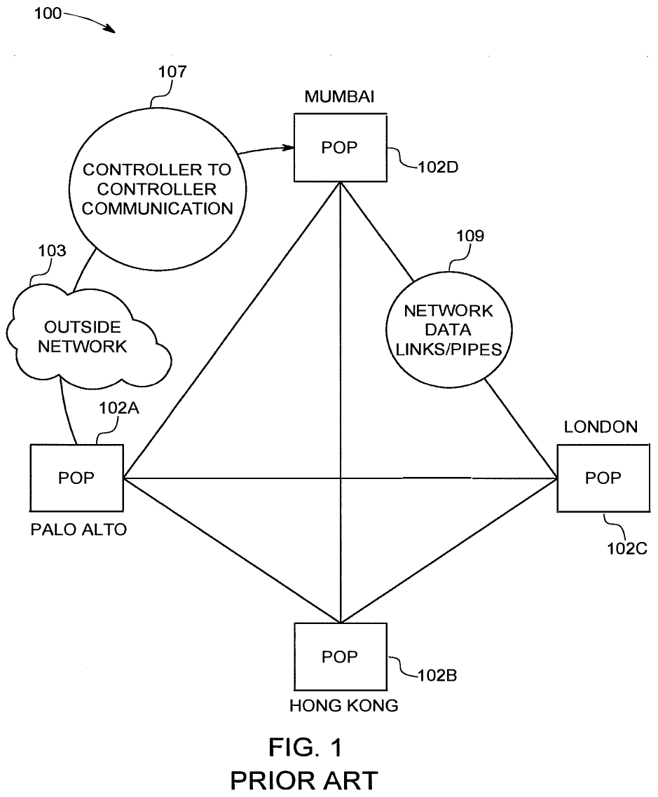

### DETAILED DESCRIPTION

Embodiments disclosed include a method and apparatus for global traffic control and optimization for software-defined networks. In an embodiment, data traffic is optimized by distributing predefined metrics (data traffic information) to all controllers in the network. The predefined metrics are specific to local network switches and controllers, but are distributed to all peers at configurable intervals. “Local” as used herein implies one POP and its associated switch and controller. The method of distribution of local POP metrics is strictly in band using a packet as defined by the protocol used by the data network. Herein, the term “control packet” is used to distinguish from a data packet.

As further described, embodiments include a proprietary software network controller local to each POP in a network. The network controllers are homogenous, and thus control packets sent between network controllers need only include chosen information (such as the predefined metrics) and minimal overhead data is required.

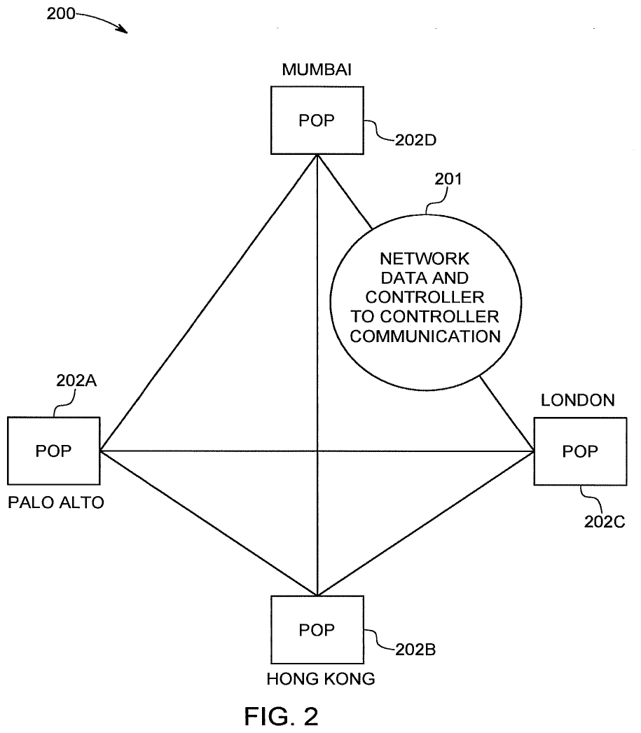

FIG. 2 is a block diagram of a data network 200 according to an embodiment. Network 200 includes (for illustration purposes) four POPs/switches (or nodes) 202, but in practice there are many more POPs. In this example, POP 202A represents Palo Alto as a physical location, but POP hardware and software do not necessarily reside in Palo Alto. The same is true of POP 202B (Hong Kong), POP 202C (London), and POP 202D (Mumbai). Network data and controller-to-controller communication links (or pipes) 201 connect all of the POPs. As further described below, both data packets and control packets are transferred via the links 201 using the same packet protocol.

FIG. 2A is a block diagram of a POP 202. Each POP includes a switch 203, which is typically a software switch, and controller/routing software 205. Each POP also includes processor capability 207 which may be local or not, and memory 209. Processor capability 207 can be one or more physical CPUs located anywhere. Memory 209 includes a distributed feedback database 209 as further described below. Memory 209 can be any type of physical data storage units located anywhere.

Each controller 202 can be referred to as a local controller. Each controller 202 talks to its own switch 203. Communication is between local controllers, but each controller is responsible for a single switch. In an embodiment, each POP is associated with a virtual machine, and for that POP, one controller is controlling one switch.

In embodiments, the controller framework is Onos (Open network operating system), which is software defined. Any other software defined framework could be used.

Controller/routing software 205 as further described below is proprietary software that performs communication between controllers in the network, collection and distribution of metric data for each controller, and formation of routing instructions for each controller.

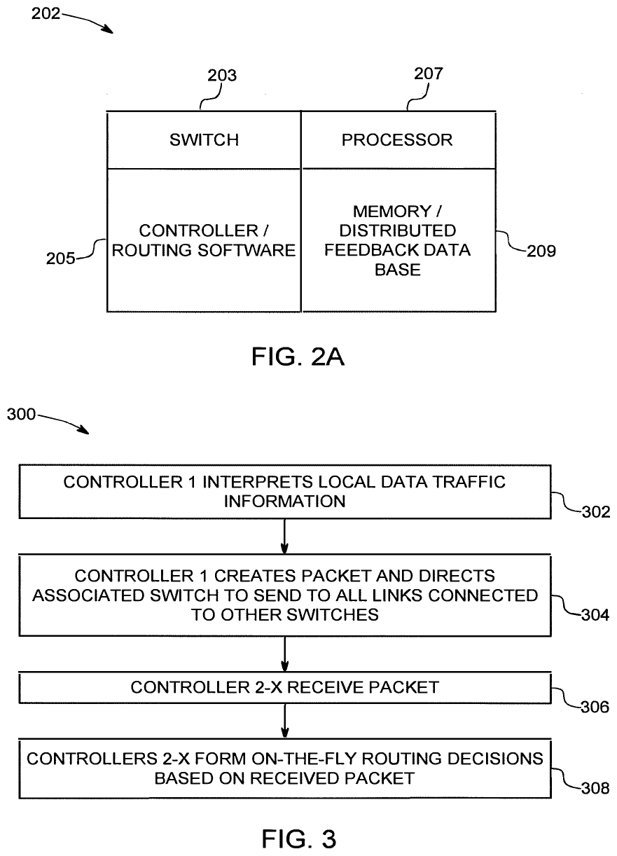

FIG. 3 is a flow diagram of a method 300 of distributed data network traffic control according to an embodiment. At 302 a controller (called controller 1 here for convenience) interprets its own local traffic information (data). As previously stated, controller 1 is associated with one switch. Accordingly, at 304, controller 1 creates a packet containing its local traffic information and distributes the packet across all of the links connected to other controller/switch pairs.

Controller 2-x (the number of controllers being variable, but inferring all of the controllers in the network) receives the packet sent by controller 1 (306).

Controllers 2-x form on-the-fly routing decisions based on the received packet (308).

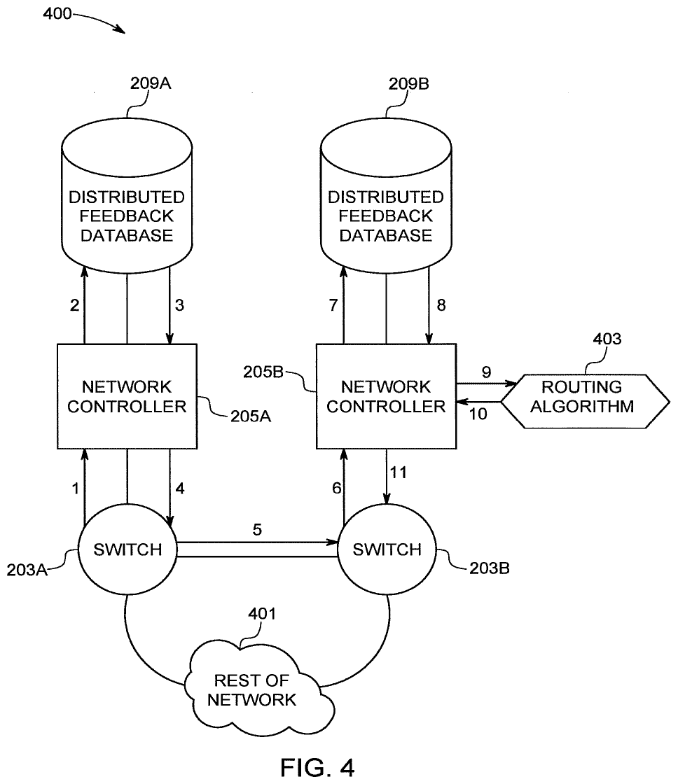

FIG. 4 is a flow diagram illustrating a data routing method according to an embodiment. FIG. 4 shows more detail of the method of FIG. 3. This diagram shows two switches, switch 1 and switch 2. As been previously stated, many more switches will be typically involved. Referring to switch 1 at 203A, switch 1 in an embodiment is an Open vSwitch (OVS) virtual switch, but embodiments are not so limited.

The traffic data collected by switch 1 is sent to associated network controller 205A (see arrow 1). The local feedback database 209A associated with network controller 205A and switch 1 (203A) is updated with the collected information (see arrow 2). At arrow 3, the network controller 205A then pulls data from the feedback database to report to all other controllers in the network.

At arrow 4, the network controller 205A instructs the local switch 1 (203A) to create and send a specific control packet containing the latest feedback data (also referred to as traffic data or traffic information). The control packet is then sent in band to a neighboring switch, in this case switch 2 (203B). Switch 1 (203B) forwards the packet to its associated local controller 205B as shown with arrow 6. Controller 2015B processes the received packet and updates its associated feedback database 209B (see arrow 7). Network controller 205B pulls data from the feedback database 209B as input to a routing algorithm 403 (arrows 8 and 9). Network controller 205B receives optimum routing data based on the output to the routing algorithm 403 (arrow 10). Network controller 205B then sends a message to switch 2 to install routing rules based on the output of routing algorithm 403. In an embodiment, the message is an OpenFlow message that includes instructions to create and distribute control packets and to install forwarding rules.

In an embodiment, control packets are based on the PWOSPF protocol, with some modification to support additional data needed by the routing algorithm 403, but other protocols could be used. PWOSPF is a simplified link state routing protocol based on industry standard OSPFv2. Rules and metrics are conveyed by the protocol. Rules are updates for each instruction to a switch based on the information received from the routing algorithm. Metrics are predefined to include metrics of interest. In an embodiment, metrics include latency, packet loss, and utilization.

OVS switch 1 (203A) knows how much data is going through its connected pipes. In an embodiment, a link utilization algorithm is used. Link utilization is also a metric in an embodiment, which is meaningful given that each switch has finite capacity. Accordingly, link utilization is one type of data that the controller receives at arrow 1. When the database 209A receives the data it is saved locally and also prepares the control packet to be transmitted to peers. Transmission to peers does not necessarily happen each time data is received (arrow 1). For example, data can be collected every second r ten times/second. Alternatively, the data packed for transmission may include an average of the last X number of data items.

On a predetermined time basis the controller 2015A checks the database 209A find the most recent information. The packet is on the database 209A. At arrow 3, the controller 205A obtains the packet from the database 209A and directs the switch 203A to send to all peers/neighbors.

When controller 205B receives the packet, it determines whether the packet is not older than one already in the database 209B. If it is not older, the packet is saved to the database (arrow 7) as a switch 1 packet for whoever whichever peer controller wishes to use it. As previously stated, in practice, there are many packets from many switches not shown in FIG. 4.

When controller 205B performs routing, it updates the rules on the switch 203B as well. Controller 205B goes to database 209B and asks for all the latest control packets including its own. Controller 205B receives the packets (step 8) and makes them accessible to a routing algorithm as previously described.

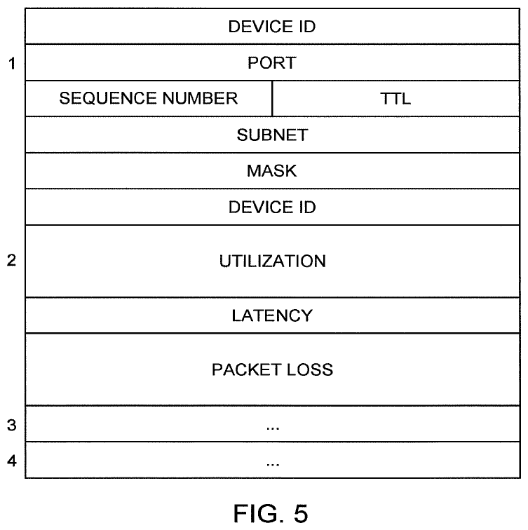

FIG. 5 is a block diagram of a control packet according to an embodiment. Reference 1 indicates the header packet which includes information according to the protocol to route and schedule the packet.

References 2, 3 and 4 make up the packet body. Reference 2 refers to information regarding the metrics for one specific link. References 2, 3 and 4 essentially repeat the information included in reference 2, but include information regarding metrics for multiple links.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that the various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

While certain aspects of the systems and methods are presented below in certain claim forms, the inventors contemplate the various aspects of the systems and methods in any number of claim forms. For example, while only one aspect of the systems and methods may be recited as embodied in machine-readable medium, other aspects may likewise be embodied in machine-readable medium. Accordingly, the inventors reserve the right to add additional claims after filing the application to pursue such additional claim forms for other aspects of the systems and methods.

What is claimed is:

1. A method comprising:
collecting, by a first network controller at a point of presence, traffic data from a network switch;
storing the traffic data in a first feedback database associated with a first network controller;
generating a control packet containing the traffic data from the local feedback database;
transmitting the control packet to a second network controller using one or more communication links;
receiving the control packet by the second network controller;
updating a second feedback database associated with the second network controller with the traffic data from the received control packet;
providing a routing decision using at least the second feedback database; and
directing the second switch to route data packets according to the routing decision.

2. The method of claim 1, wherein the one or more communication links comprise an in-band communication link.

3. The method of claim 1, wherein the control packet includes a timestamp indicating when the traffic data was collected.

4. The method of claim 1, wherein the traffic data comprise metrics selected from the group consisting of latency, packet loss, throughput, and link utilization.

5. The method of claim 1, further comprising prioritizing a transmission of the control packet based on an urgency of the traffic data.

6. The method of claim 1, wherein the first feedback database is configured on multiple physical locations.

7. The method of claim 1, wherein the control packet comprises an identifier for the point of presence from which the traffic data was collected.

8. The method of claim 1, wherein the control packet is transmitted using a multicast protocol.

9. The method of claim 1, wherein the second network controller is configured to autonomously adjust routing policies based on the received control packets.

10. The method of claim 1, further comprising synchronizing the first database and the second database.

11. A non-transitory machine readable medium storing a controller program which when executed by a processor, the controller program comprising sets of instructions for:
collecting, by a first network controller at a point of presence, traffic data from a network switch;
storing the traffic data in a first feedback database associated with a first network controller;
generating a control packet containing the traffic data from the local feedback database;
transmitting the control packet to a second network controller using one or more communication links;
receiving the control packet by the second network controller;
updating a second feedback database associated with the second network controller with the traffic data from the received control packet;
providing a routing decision using at least the second feedback databases; and
directing the second switch to route data packets according to the routing decision.

12. The non-transitory machine readable medium of claim 11, wherein the one or more communication links comprise an in-band communication link.

13. The non-transitory machine readable medium of claim 11, wherein the control packet includes a timestamp indicating when the traffic data was collected.

14. The non-transitory machine readable medium of claim 11, wherein the traffic data comprise metrics selected from the group consisting of latency, packet loss, throughput, and link utilization.

15. The non-transitory machine readable medium of claim 11, wherein controller program further comprises instructions for prioritizing a transmission of the control packet based on an urgency of the traffic data.

16. The non-transitory machine readable medium of claim 11, wherein the first feedback database is configured on multiple physical locations.

17. The non-transitory machine readable medium of claim 11, wherein the control packet comprises an identifier for the point of presence from which the traffic data was collected.

18. The non-transitory machine readable medium of claim 11, wherein the control packet is transmitted using a multicast protocol.

19. The non-transitory machine readable medium of claim 11, wherein the second network controller is configured to autonomously adjust routing policies based on the received control packets.

20. The non-transitory machine readable medium of claim 11, further comprising synchronizing the first database and the second database.
